(19) United States
(12) Patent Application Publication
(10) Pub. No.: US 2025/0356013 A1
(43) Pub. Date: Nov. 20, 2025

(54) INFORMATION PROCESSING APPARATUS, METHOD OF CONTROLLING INFORMATION PROCESSING APPARATUS, AND STORAGE MEDIUM

(71) Applicant: CANON KABUSHIKI KAISHA, Tokyo (JP)

(72) Inventor: YUKI MINETOMO, Kanagawa (JP)

(21) Appl. No.: 19/200,883

(22) Filed: May 7, 2025

(30) Foreign Application Priority Data
May 16, 2024 (JP) 2024-080373

(51) Int. Cl. G06F 21/56; G06F 21/55

(52) U.S. Cl. CPC G06F 21/566; G06F 21/554

(57) ABSTRACT

An information processing apparatus configured to detect unauthorized execution of a process, the information processing apparatus comprising: a monitoring unit configured to monitor a physical input to the information processing apparatus; a specifying unit configured to specify an execution condition of the process; and a detecting unit configured to detect unauthorized execution of the process based on the physical input monitored by the monitoring unit and the execution condition specified by the specifying unit.

### BACKGROUND OF THE INVENTION

### Field of the Invention

The present invention relates to an information processing apparatus, a method of controlling the information processing apparatus, and a storage medium.

### Description of the Related Art

In recent years, damage caused by cyberattacks targeting information processing apparatuses is increasing. Along with this, various security measures are implemented, but it is becoming difficult to take measures with known security measures such as malware detection and firewalls due to sophistication of cyberattacks. In particular, it is difficult to defend an attack using an unknown vulnerability called zero-day attack, and there are cases where an attacker intruded into the system of an information processing apparatus by the zero-day attack that abuses the system and damages individuals and companies. For such sophisticated attacks, in addition to the defense at a known network boundary, it is necessary to implement security measures to monitor the behavior of the system and detect an attack attempting to abuse the system.

Japanese Patent No. 4995170 discloses installing a monitoring monitor for each module executed by an information processing apparatus, and collating execution information on the module executed by the monitor with an execution condition of the module held in advance, thereby detecting an attack that abuses a process.

However, the technique described in Japanese Patent No. 4995170 has a problem of failing to detect that an attack that abuses a normal process as it is. In Japanese Patent No. 4995170, the monitoring monitor provided in the module monitors whether arguments and sequences of an API and a system call called by the module behave correctly. Therefore, it is not possible to detect an attack in which an attacker abuses the process of an information processing apparatus as it is. For example, there is a denial of service (DOS) attack aiming at consumption of resources and disturbance of business by performing unauthorized execution of a print process of a multi-function peripheral (MFP) and causing a large amount of printing. In the case of this DOS attack, the attacker establishes the attack by calling a large number of authorized print processes. Hence, since the monitoring monitor recognizes that the behavior itself of the module is correct, it cannot be detected as an attack by the technique described in Japanese Patent No. 4995170.

### SUMMARY OF THE INVENTION

The present invention has been made in view of the above problems, and provides a technique for detecting unauthorized use of a process when the process of an information processing apparatus is executed.

According to one aspect of the present invention, there is provided an information processing apparatus configured to detect unauthorized execution of a process, the information processing apparatus comprising: a monitoring unit configured to monitor a physical input to the information processing apparatus; a specifying unit configured to specify an execution condition of the process; and a detecting unit configured to detect unauthorized execution of the process based on the physical input monitored by the monitoring unit and the execution condition specified by the specifying unit.

Further features of the present invention will become apparent from the following description of exemplary embodiments (with reference to the attached drawings).

### BRIEF DESCRIPTION OF THE DRAWINGS

FIG. 1 is a view illustrating a configuration example of a system including an MFP according to one embodiment and peripheral devices.

FIG. 2 is a hardware configuration diagram of a controller unit of the MFP according to one embodiment.

FIG. 3 is a software configuration diagram of the controller unit of the MFP according to one embodiment.

FIG. 4 is a physical input record table according to one embodiment.

FIG. 5 is a table of process and physical input according to one embodiment.

FIG. 6 is a flowchart showing a procedure of processing according to one embodiment.

FIG. 7 is a flowchart showing a procedure of processing according to Modification 1.

FIG. 8 is a table of a process and a preliminary operation according to Modification 2.

FIG. 9 is a flowchart showing a procedure of processing of Modification 2.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### Embodiment

In the present embodiment, processing of collating a process to be executed by an information processing apparatus with a physical input state by the user, and in a case of detecting inconsistency in an execution condition of the process, determining it as an attack on the system, and implementing a security measure will be described. The process here is a process for executing a function of the MFP, and corresponds to, for example, printing, scanning, setting change of the MFP, and the like. In the present embodiment, an MFP, which is an image forming apparatus, will be described as an example of an information processing apparatus, but the present embodiment is a technique applicable to information processing apparatuses other than the MFP.

### System Configuration

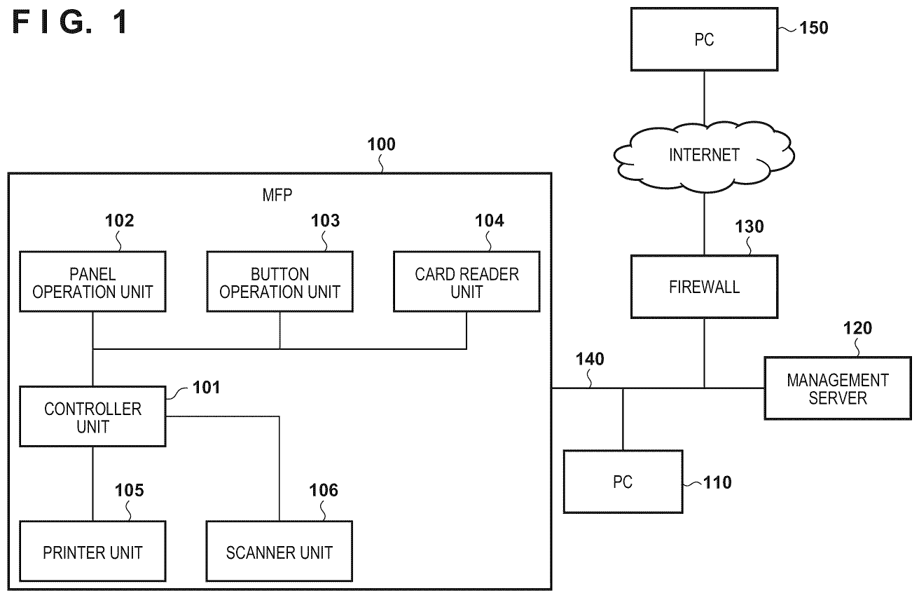

A configuration example of a system including an MFP according to one embodiment and peripheral devices will be described with reference to the block diagram of FIG. 1. An information processing apparatus (MFP) 100, a personal computer (PC) 110, and a management server 120 are connected via a LAN 140. The PC 110 performs processing such as transmission and reception of a print job and a scan job to and from the MFP 100. The management server 120 manages the MFP 100, and when the MFP 100 is integrated in an authentication system of an organization, executes authentication and authorization of a user who accesses the MFP 100. When the MFP 100 or the management server 120 is connected to the Internet, the connection is made via a firewall 130. The PC 150 is connected to the MFP 100 and the management server 120 via the Internet, and can access the MFP 100.

The MFP 100 includes a controller unit 101, a panel operation unit 102, a button operation unit 103, a card reader unit 104, a printer unit 105, and a scanner unit 106.

The controller unit 101 controls various operations of the MFP 100. The panel operation unit 102 includes an electronic panel for performing input/output with the user, and the user can operate the MFP 100 by performing touch input. The button operation unit 103 includes physical buttons for performing input/output with the user, and the user can operate the MFP 100 by pressing the physical button.

When the user holds an integrated circuit (IC) card over the card reader unit 104, the card reader unit 104 can read card information and authenticate the user. The printer unit 105 outputs electronic data to a paper medium. The scanner unit 106 reads a paper medium and converts the paper medium into electronic data. The scanner unit 106 recognizes an open/close state of a cover of a scanner body by a sensor, and performs lighting of a light-emitting diode (LED) and notification of the open/close state of the cover. The panel operation unit 102, the button operation unit 103, the card reader unit 104, the printer unit 105, and the scanner unit 106 are connected to the controller unit 101, and implement a function as a multifunction peripheral under the control of the controller unit 101.

### Hardware Configuration

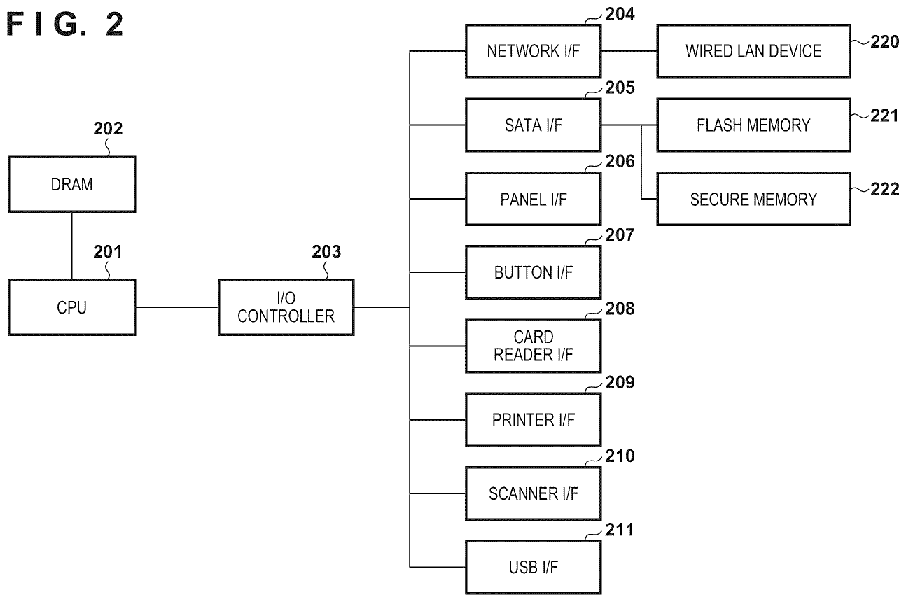

FIG. 2 is a block diagram illustrating a hardware configuration of the controller unit 101 of the MFP 100 according to one embodiment. The CPU 201 performs main operation processing in the controller unit 101. The CPU 201 is connected to a DRAM 202 via a bus. The DRAM 202 is used by the CPU 201 as a working memory for temporarily placing program data representing an operation command and data of a processing target in the process of operation by the CPU 201. The CPU 201 is further connected to an I/O controller 203 via the bus. The I/O controller 203 inputs/outputs various devices in accordance with an instruction from the CPU 201.

A network I/F 204 is connected to the I/O controller 203. A wired LAN device 220 is connected beyond the network I/F 204. The CPU 201 implements communication on the LAN 140 by controlling the wired LAN device 220 via the network I/F 204.

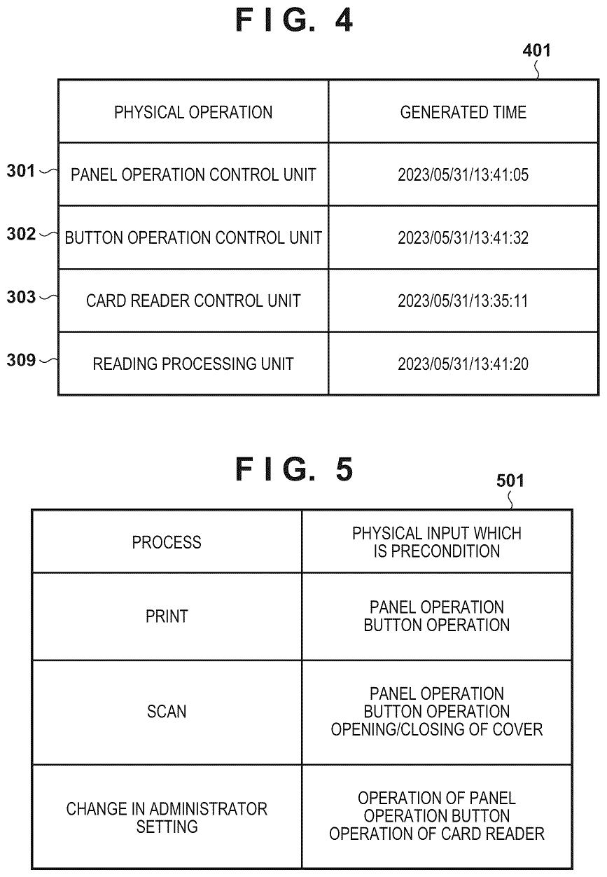

A serial advanced technology attachment (SATA) I/F 205 is connected to the I/O controller 203. A flash memory 221 and a secure memory 222 are connected beyond the SATA I/F 205. The CPU 201 uses the flash memory 221 in order to permanently store a program for implementing the functions of the MFP 100 and a document file. The CPU 201 uses the secure memory 222 in order to store data important for security. The secure memory 222 is encrypted and can only be accessed from a specific module by access control. Therefore, it is protected from leakage of confidential information and unauthorized rewriting. The secure memory 222 stores information requiring confidentiality and integrity, such as user authentication information, an encryption key, and a physical input record table 401 illustrated in FIG. 4 described later.

A panel I/F 206 is connected to the I/O controller 203. The panel I/F 206 converts the physical operation of the user input to the panel operation unit 102 into electronic data and transmits the electronic data to the CPU 201, thereby implementing the user operation. A button I/F 207 is connected to the I/O controller 203. The button I/F 207 converts the physical operation of the user input to the button operation unit 103 into electronic data and transmits the electronic data to the CPU 201, thereby implementing the user operation.

A card reader I/F 208 is connected to the I/O controller 203. The card reader I/F 208 converts the read information on the IC card input to the card reader unit 104 into electronic data and transmits the electronic data to the CPU 201, thereby implementing an authentication operation and the like. A printer I/F 209 is connected to the I/O controller 203. The CPU 201 implements output processing of a paper medium using the printer unit 105 via the printer I/F 209.

A scanner I/F 210 is connected to the I/O controller 203. The CPU 201 implements reading processing of a document using the scanner unit 106 via the scanner I/F 210. The scanner I/F 210 notifies the CPU 201 of the open/close state of the cover of the scanner. A USB I/F 211 is connected to the I/O controller 203. The USB I/F 211 controls arbitrary equipment connected to the USB I/F 211.

When executing a copy function, the CPU 201 reads a program from the flash memory 221 to the DRAM 202 via the SATA I/F 205. The CPU 201 detects a copy instruction from the user to the panel operation unit 102 and the button operation unit 103 via the panel I/F 206 and the button I/F 207 in accordance with the program read into the DRAM 202. Upon detecting the copy instruction, the CPU 201 receives, as electronic data, the document from the scanner unit 106 via the scanner I/F 209, and stores the electronic data in the DRAM 202. The CPU 201 executes, for example, color conversion processing suitable for output on image data stored in the DRAM 202. The CPU 201 transfers the image data stored in the DRAM 202 to the printer unit 105 via the printer I/F 209, and executes output processing to a paper medium. As described above, the copy function can be implemented by combining the print function and the scan function. Note that the CPU 201 and the other modules have independent configurations, and input/output data via the I/O controller 203, and therefore the other modules cannot be directly controlled.

When executing the PDL print function, a client PC 110 issues a print instruction via the LAN 140. The CPU 201 reads the program from the flash memory 221 to the DRAM 202 via the SATA I/F 205, and detects a print instruction via the network I/F 204 in accordance with the module read into the DRAM 202. Upon detecting a PDL transmission instruction, the CPU 201 receives print data via the network I/F 204 and stores the print data into the flash memory 221 via the SATA I/F 205. Upon completing the storage of the print data, the CPU 201 develops, as image data, into the DRAM 202, the print data stored in the flash memory 221. The CPU 201 executes, for example, color conversion processing suitable for output on image data stored in the DRAM 202. The CPU 201 transfers the image data stored in the DRAM 202 to the printer unit 105 via the printer I/F 209, and executes output processing to a paper medium.

### Software Configuration

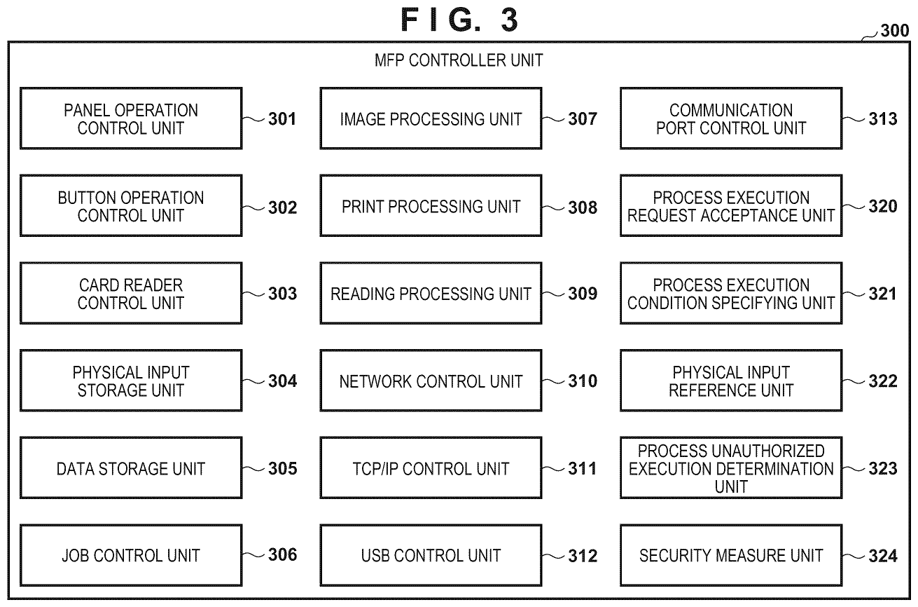

Next, a functional configuration example implemented by software executed by the controller unit of the MFP according to the present embodiment will be described with reference to the block diagram of FIG. 3.

A panel operation control unit 301 displays a screen image for the user on the panel operation unit 102, and executes processing of detecting a touch operation by the user and processing associated with a screen component such as a button displayed on the screen. A capacitative touch panel is used for detection of a touch operation. In this method, a touch position is detected by capturing a change in capacitance when a user's finger touches a panel. The panel operation control unit 301 converts the change in capacitance described above into digital data and transmits the data to another control unit. Here, the capacitative touch panel has been exemplified, but another method of detecting a touch position of the user may be used.

A button operation control unit 302 executes processing associated with the button when the user presses the button arranged in the button operation unit 103. At the time of button operation, the button operation control unit 302 converts a change in voltage due to button pressing into digital data and transmits the data to another control unit.

A card reader control unit 303 executes processing corresponding to information read by reading an IC card held by the user by a reader arranged in the card reader unit 104. A contactless reader is used to read the IC card. The card reader reads information by electromotive force of electromagnetic induction generated by passing through a magnetic field of the reader when the IC card approaches. The card reader control unit 303 converts the change in the electromotive force described above into digital data and transmits the data to another control unit. Here, the contactless IC card reader has been exemplified, but another type of card reader may be used.

A physical input storage unit 304 records a result of the physical input having been input via the panel operation control unit 301, the button operation control unit 302, and the card reader control unit 303. The physical input storage unit 304 writes, into the physical input record table 401 of the secure memory 222, a change in the physical quantity caused by any operation of each operation control unit and a time when the change is generated.

As illustrated in FIG. 4, the physical input record table 401 records the type of the physical operation and the generation time which is the time of generation of the operation. The generation time information is recorded in a format of year/month/day/time. Here, the date and time are exemplified as the time information, but information indicating other times such as a system time may be used. Writing operation to the physical input record table 401 can be performed only from the physical input storage unit 304, but reading operation can be performed from another module.

Since the physical input storage unit 304 executes only a function of reading a physical input from each operation control unit and a function of writing a result thereof, it does not accept a command from another control unit. Therefore, it is not possible to perform an operation of writing an arbitrary input record by abusing the physical input storage unit 304. Here, the secure memory 222 is exemplified as a storage for protecting the physical input record table 401, but another storage that can protect the confidentiality and integrity of stored information, such as a trusted platform module (TPM), may be used. Note that for the time information, time synchronization is performed by using a reliable network time protocol (NTP) server to guarantee correct time. Here, use of the NTP server is exemplified as a guarantee method of time information, but the time information may be protected by another method.

A data storage unit 305 performs processing of storing data into the flash memory 221 or reading data from the flash memory 221 in response to a request from another control unit. For example, in a case where the user desires to change equipment setting, the panel operation control unit 301 detects content input by the user to the panel operation unit 102, and the data storage unit 304 stores the changed setting value into the flash memory 221 in response to a request from the panel operation control unit 301.

A job control unit 306 controls job execution in accordance with an instruction from another control unit. An image processing unit 307 processes image data into a format suitable for each use in accordance with an instruction from the job control unit 306. In accordance with an instruction from the job control unit 306, a print processing unit 308 prints and outputs an image on a paper medium via the printer I/F 209.

A reading processing unit 309 reads an installed document via the scanner I/F 210 in accordance with an instruction from the job control unit 306. The reading processing unit 309 executes a lighting operation of an LED or the like depending on the open/close state of the cover detected by the scanner I/F 210. A network control unit 310 performs network setting such as an IP address on a TCP/IP control unit 311 at the time of system start or at the time of setting change detection in accordance with the setting value stored in the data storage unit 305.

The TCP/IP control unit 311 performs transmission/reception processing of a network packet via the network I/F 204 in accordance with an instruction from another control unit. A USB control unit 312 controls the USB I/F 211 and controls arbitrary equipment connected via the USB. A communication port control unit 313 controls a port used when the TCP/IP control unit 311 performs transmission/reception of packets.

A process execution request acceptance unit 320 accepts a process execution request from the CPU 201. Examples of the process include printing, scanning, setting change, and administrator authentication, and these are processes in which the physical input of the MFP by the user is a precondition for execution. The execution request for these processes is generated by an operation input by the user via the panel operation unit 102 or the button operation unit 103.

A process execution condition specifying unit 321 specifies a physical input in which the process execution request accepted by the process execution request acceptance unit 320 is a precondition for execution. A process-physical input correspondence table 501 illustrated in FIG. 5 is used for specification of the physical input as a precondition for execution. The process-physical input correspondence table 501 describes a process executed in the MFP and a physical input which is a precondition for execution of the process.

For example, in a case of a print process, when the user presses a button of the MFP or inputs with the touch panel at the time of printing, the print process is started and printing is executed. In a case of a scan process, scan processing is executed by opening/closing of the cover for reading the scan target and pressing a button or inputting with a touch panel similarly to the print process.

In the case of an administrator setting change process, authentication of the administrator is executed at the time of setting the MFP. The administrator authentication is executed by input of an administrator ID and a password by a panel/button operation of the MFP or by user authentication using an IC card. After accepting the process execution request, by referring to the process-physical input correspondence table 501, the process execution condition specifying unit 321 specifies a physical input which is a precondition for process execution, and notifies a physical input reference unit 322 to acquire a corresponding physical input state.

The physical input reference unit 322 acquires a time of generation of a physical input which is a precondition for execution of a process for which an execution request is received in response to a request from the process execution condition specifying unit 321. When referring to the physical input, the physical input record table 401 illustrated in FIG. 4 is used. The physical input record table 401 describes the module in which the physical input is performed and the time when the physical input is generated.

For example, it is assumed that an execution request for a print process is generated by an electronic panel operation by the user. The panel operation control unit 301 detects execution of the electronic panel operation, and a generation time thereof is described in the physical input record table 401. Similarly to the electronic panel operation, the button pressing operation is recorded as the operation generation time of the button control unit 302, the reading operation of the IC card is recorded as the operation generation time of the card reader control unit 303, and the open/close operation of the cover at the time of scanning is recorded as the operation generation time of the reading processing unit 309. For the time of generation the physical input to be recorded, it is not necessary to record the time of generation of the history, and only the latest generation time may be recorded. The physical input reference unit 322 acquires, from the physical input record table 401, the time of generation of the process designated by the process execution condition specifying unit 321, and passes it to a process unauthorized execution determination unit 323.

The process unauthorized execution determination unit 323 determines whether the execution request of the process accepted by the process execution request acceptance unit 320 is not unauthorized. The process unauthorized execution determination unit 323 collates the time information at which the process execution request acceptance unit 320 accepted the process execution request with the time of generation of the physical input which is a precondition for the process acquired by the physical input reference unit 322.

For example, an execution request for a print process is assumed to be generated in “2023 Jun. 1/06:00:00”. The print process is premised upon a panel operation or a button operation from the process-physical input table 501, and the process unauthorized execution determination unit 323 receives the time of generation of the physical input related to the panel operation or the button operation from the physical input reference unit 322. The time of generation of the physical input acquired by the physical input reference unit 322 is assumed to be a panel operation “2023 May 31/13:41:05” and a button operation “2023 May 31/13:41:32”.

In this case, the time of generation of the physical input has a clear deviation from the time of generation of the process execution request. Thus, when the time of generation of the execution request for the process and the time of generation of the physical input which is a precondition for the process execution are not the same or within a predetermined time range, it can be determined as unauthorized execution of the process.

For example, when the user presses the button to execute the print function, the time from the detection of the button pressing to the execution of the process does not take one second or more on an assumption of embedded equipment. That is, it is possible to determine that there is an abnormality only by a deviation of several seconds or more from the generation of the physical input last time to the process execution.

It is also difficult for the attacker to observe the behavior of the user and cause a false process to be executed within a predetermined time in accordance with the user's action. The unauthorized execution of the process here means that the attacker intrudes into the system of the MFP and executes the process without going through an authorized procedure. Using the vulnerability or the like of the MFP, the attacker performs unauthorized access to the system of the MFP. This unauthorized access enables unauthorized calling of a function of the MFP, and enables a DOS attack causing a large amount of paper to be printed to waste resources or an attack performing unauthorized transfer of data in the MFP by using fax or a mail. When it is determined that such unauthorized execution of the process has been generated, a security measure unit 324 implements a measure. When there is no deviation between the time of generation of the process and the time of generation of the physical input which is a precondition, it is regarded as an authorized process execution request, and the requested process is executed.

The security measure unit 324 implements the security measure when the process unauthorized execution determination unit 323 detects the unauthorized execution of the process. Since it is assumed that the fact that unauthorized execution of the process is being performed means that an attacker has intruded into the system in an unauthorized manner, the access by the attacker is blocked by restarting the system. At that time, the administrator is notified that an attack to the system has been generated, and a measure is urged.

### Processing

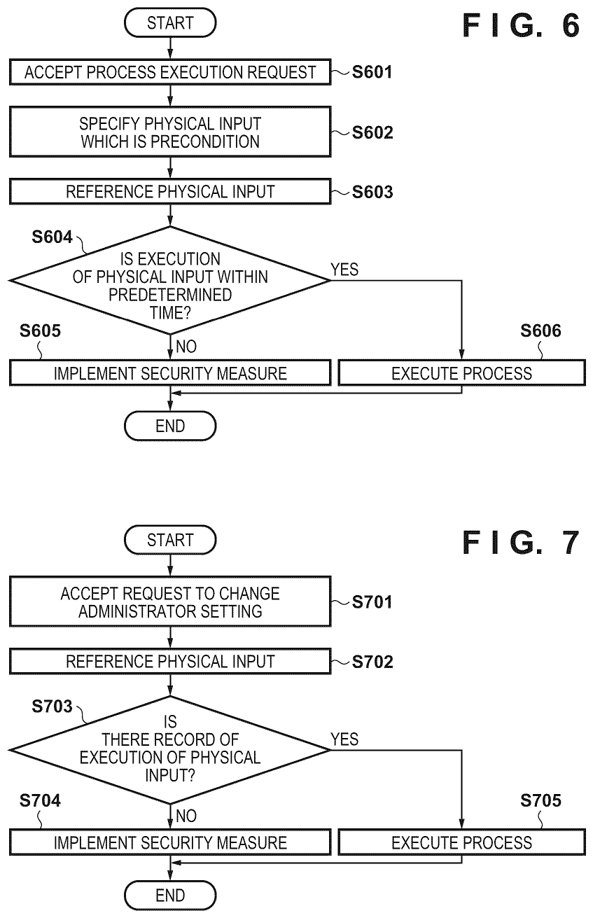

Next, a procedure of process unauthorized execution detection processing based on a state of a physical input which is a precondition for process execution according to the present embodiment will be described with reference to the flowchart of FIG. 6. In S601, the process execution request acceptance unit 320 accepts an execution request of a process. In S602, the process execution condition specifying unit 321 specifies a physical input that is a precondition for execution by the process for which an execution request is made. In S603, the physical input reference unit 322 refers to the time of generation of the physical input which is a precondition specified by the process execution condition specifying unit 321.

In S604, the process unauthorized execution determination unit 323 collates the time of generation of the process execution request with the time of generation of the physical input. If the difference between the time of generation of the execution request for the process and the time of generation of the physical input exceeds the threshold (or is the threshold or more), the process proceeds to S605. On the other hand, if the difference is the threshold or less (or less than the threshold), the process proceeds to S606.

In step S605, the security measure unit 324 determines unauthorized execution of the process and implements the security measure. In step S605, the security measure unit 324 executes the process as it is without executing the security measure.

As described above, in the present embodiment, it is possible to detect unauthorized execution of a process preconditioned upon a physical input based on the time of generation of the process execution request and the time of generation of the physical input by the user.

### Modification 1

In the embodiment described above, unauthorized execution of the process preconditioned upon the physical input is detected, but in the present modification, an unauthorized change of the administrator setting of the MFP is detected.

When the attacker intrudes into the system of the MFP, there is a case of disabling the security setting for the purpose of destruction of evidence of the attack or expanding further damage. Such a change in the security setting requires administrator authority, but there is a case where the attacker acquires the administrator authority in an unauthorized manner by using the vulnerability of the MFP or the like and change the security setting.

In the present modification, an unauthorized change of administrator setting, which is a security setting requiring administrator authority, is detected. When the administrator setting is changed, administrator authentication of the MFP is required. In the administrator authentication, authentication using an ID and a password or authentication using an IC card is executed. In the authentication using an ID and a password, the authentication information is input using the panel operation unit 102 or the button operation unit 103 of the MFP. In the authentication using the IC card, the authentication is executed by holding the IC card over the card reader unit 104.

In these authentication methods, since a physical input to the MFP is generated, it is possible to detect an unauthorized change in the administrator setting by confirming the presence or absence of this physical input. For example, when a request to change the administrator setting is generated, the physical input reference unit 322 acquires information on the time of generation of the physical input related to the change of the administrator setting. The process-physical input table 501 describes that change of the administrator setting is preconditioned upon a panel operation/button operation (ID/password authentication) and a card reader operation (IC card authentication). The physical input reference unit 322 acquires the time of generation of the physical input, and the process unauthorized execution determination unit 323 collates the acceptance time of the change request for the administrator setting with the time of generation of the physical input that is acquired, whereby the unauthorized administrator setting can be detected. When the change is detected as an unauthorized change, the setting change for which the change request is received is not permitted, and the access of the attacker is blocked by restart and the administrator is notified.

### Processing

The processing of detecting an unauthorized change in administrator setting according to the present modification will be described with reference to the flowchart of FIG. 7. In S701, the process execution request acceptance unit 320 accepts a change request for administrator setting. In S702, the physical input reference unit 322 refers to the time of generation of the physical input related to administrator authentication.

In S703, the process unauthorized execution determination unit 323 collates the time of generation of the process execution request with the time of generation of the physical input. If the difference between the time of generation of the execution request for the process and the time of generation of the physical input exceeds the threshold (or is the threshold or more), the process proceeds to S704. On the other hand, if the difference is the threshold or less (or less than the threshold), the process proceeds to S705. In step S704, the security measure unit 324 determines unauthorized execution of the process and implements the security measure. In step S705, the security measure unit 324 executes the process as it is without executing the security measure.

As described above, according to the present modification, an unauthorized change in administrator setting can be detected.

### Modification 2

In the embodiment described above, the unauthorized execution detection of the process is performed by confirming the presence or absence of the physical input which is a precondition for the process execution, but in the present modification, unauthorized execution detection of the process is performed based on the preliminary operation at the time of process execution.

Some of process execution of the MFP always cause a preliminary operation. For example, when scan processing is executed in the MFP, an open/close operation of a cover for setting a scan target is generated. A sensor is installed in the cover, and the sensor detects open/close of the cover, thereby turning on the LED or issuing a notification on the UI. Thus, in a specific process of the MFP, there is a preliminary operation that is always generated at the time of process execution, and a sensor that detects the preliminary operation is also included.

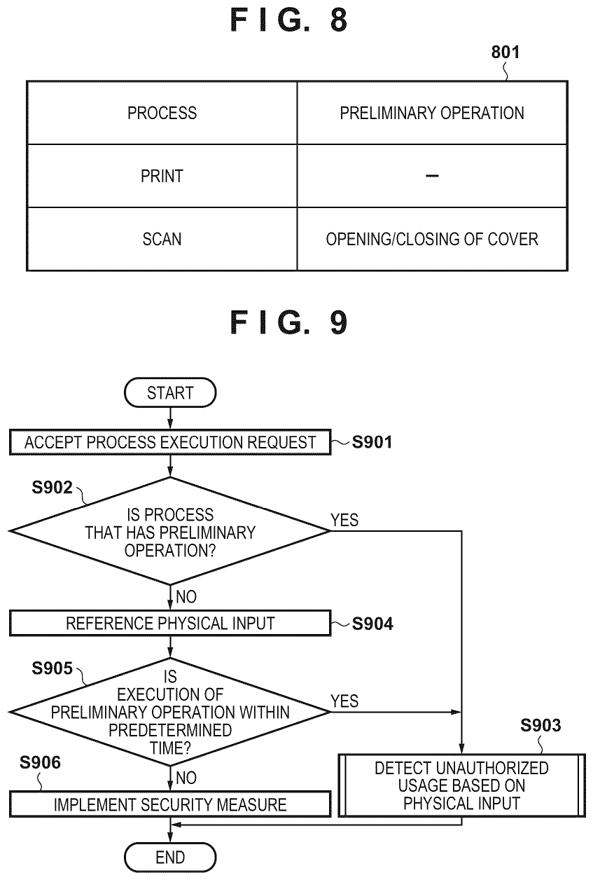

Hence, when the sensor cannot detect the execution of the preliminary operation at the time of process execution, it does not match a use case of the MFP, and therefore it is possible to detect that the process is executed in an unauthorized manner. For example, when the process execution request acceptance unit 320 accepts the execution request for the process, by referring to a process-preliminary operation table 801 illustrated in FIG. 8, the process execution condition specifying unit 321 determines whether or not there is a preliminary operation related to the process. The process-preliminary operation table 801 describes the presence or absence of a preliminary operation related to the process to be executed. For example, regarding the scan process, a cover open/close operation when setting the target at the time of scanning is described as a preliminary operation.

If it is determined that there is a preliminary operation at the time of process execution with reference to the process-preliminary operation table 801, unauthorized execution is detected by confirming the presence or absence of generation of the preliminary operation. The presence or absence of generation of the preliminary operation can be confirmed by the physical input reference unit 322 referring to the time of generation of the corresponding physical input from the physical input record table 401. When the difference between the generated time of the preliminary operation and the generated time of the process execution is not the threshold or less, unauthorized execution of the process can be determined.

### Processing

With reference to the flowchart of FIG. 9, processing of detecting unauthorized execution based on the presence or absence of a preliminary operation according to the present modification will be described. In S901, the process execution request acceptance unit 320 accepts the execution request for the process from the CPU 201.

In S902, the process execution condition specifying unit 321 determines the presence or absence of the preliminary operation of the process for which the execution request has been made. If the process is not preconditioned upon the preliminary operation, the process proceeds to S903. On the other hand, if the process is preconditioned upon the preliminary operation, the process proceeds to S904. In S903, processing for confirming the physical input which is a precondition for process execution shown in the flowchart of FIG. 6 is executed.

In S904, the physical input reference unit 322 refers to the time of generation of the preliminary operation. In S905, the process unauthorized execution determination unit 323 collates the time of generation of the process execution request with the time of generation of the preliminary operation. If the difference between the time of generation of the execution request for the process and the time of generation of the preliminary operation exceeds the threshold (or is the threshold or more), the process proceeds to S906. On the other hand, if the difference is the threshold or less (or less than the threshold), the process proceeds to S903. In step S906, the security measure unit 324 implements the security measure as the unauthorized execution of the process.

As described above, according to the present modification, unauthorized execution of the process can be detected using the preliminary operation of the process.

### Modification 3

In the embodiment described above, the detection of the unauthorized execution of the process preconditioned upon the physical input is performed, but in the present modification, detection of unauthorized execution of the process in consideration of the state of the remote user interface (RUI) function is performed. Processes such as printing and scanning of the MFP are executed by input with an electronic panel or a physical button installed in the MFP main body, but some models of the MFP have a function of performing process execution by a remote operation using the RUI. In the case of using the RUI, the user transmits an execution command of a process from a PC or a smartphone using a communication protocol such as http, and the MFP that has received the command performs execution of the process. Therefore, there is a case where the MFP having the RUI function cannot detect unauthorized execution of a process using physical input.

In the present modification, when a process to be executed can issue an execution command by using the RUI, it is determined whether the physical input is a precondition for process execution by confirming the state of the function of the RUI. Use of the RUI function requires setting of enabling the RUI function in the setting of the MFP, and also requires opening a communication port.

In the present modification, it is determined whether or not the physical input is a precondition by confirming this RUI setting and the state of the communication port. When the RUI setting is disabled or the communication port used for the RUI is disabled, the user needs to operate the electronic panel or the physical button of the MFP main body for process execution. Hence, when it is confirmed that the RUI function is disabled, it is possible to detect unauthorized execution of a process preconditioned upon the physical input of the embodiment. By disabling the RUI setting, the user can use an unauthorized execution detection function for a process preconditioned upon a physical input.

As described above, according to the present modification, by disabling the RUI function, it is possible to detect unauthorized execution of a process preconditioned upon a physical input.

### Modification 4

In the embodiment described above, the unauthorized execution detection of the process is performed by confirming a physical input necessary for the process execution, but in the present modification, unauthorized execution detection of a process is performed by a human sensor. Some models of MFP include a human sensor, and these models can execute an operation such as sleep release when a human approaches. Since the attacker can remotely execute an unauthorized operation by intruding into the system of the MFP from the network, the attacker can execute, in an unauthorized manner, a process originally requiring a user operation. However, if the human sensor cannot detect the user at the time of execution or immediately before execution of the process, it can be determined that the process has been executed in a state where the user is not near the MFP.

Therefore, if a process preconditioned upon a physical input of the MFP is executed even though there is no reaction in the human sensor, it can be detected as unauthorized execution of the process.

As described above, according to the present modification, whether or not the user exists near the information processing apparatus is further monitored using the human sensor, and if the process preconditioned upon the physical input is executed even though there is no reaction in the human sensor, unauthorized execution of the process is detected. This can detect the unauthorized execution of the process preconditioned upon the physical input using the human sensor.

### Modification 5

In the embodiment described above, the unauthorized execution detection of the process is performed by confirming the physical input necessary for process execution, but in the present modification, the unauthorized execution detection of the process is performed based on the charging status.

Some models of MFP require charging at the time of using a function, and these models can execute printing or scanning by the user inserting a coin into a charging apparatus provided in the MFP. When intruding into the system of the MFP from the network, the attacker can use the function of the MFP without charging money by operating the system in an unauthorized manner. Since the MFP includes a sensor for identifying a coin that is input, it is possible to identify whether or not the coin is actually input. Therefore, when the function of the MFP is used even though the sensor cannot identify the coin, it can be detected as unauthorized execution.

As described above, according to the present modification, whether or not the user has performed the charging operation for executing the process is further monitored using the charging apparatus associated with the information processing apparatus. Then, when the process is executed even though the charging operation is not performed, unauthorized execution of the process is detected. This can detect unauthorized execution of the process based on the charging status.

### Other Modifications

In the embodiment described above, measures such as restart of the system and notification to the administrator are taken as security measures at the time of unauthorized execution detection, but in the present modification, security setting is enhanced after restart.

When restart is forcibly performed as a security measure, the attacker having intruded into the system can be temporarily excluded. However, taking no measure against the intrusion method will allow intrusion of the attacker again. Therefore, in the present modification, the security is enhanced after restart, thereby suppressing re-intrusion of the attacker. For example, intrusion from the outside is prevented by enabling the firewall function of the MFP and blocking the connection from the outside of the network to which the MFP belongs. By implementing such a security measure, it is possible to suppress re-intrusion of the attacker. Regarding what security measure is to be implemented, a measure determined in advance by the system may be implemented, or a security measure determined by the user may be implemented.

Note that the physical input described in the embodiment described above can include various inputs such as button pressing, touch panel operation, IC card holding operation (voltage change), human sensor, and sensing of a coin at the time of charging. The process described in the embodiment described above can include various processes such as copying, scanning, faxing, administrator authentication (using an IC card), sleep release, and charging.

As described above, according to the present invention, unauthorized execution of the process can be detected by monitoring the state of a physical input serving as an execution condition of the process at the time of process execution of the information processing apparatus, and confirming whether or not the physical input serving as the execution condition at the time of process execution is executed.

According to the present invention, it is possible to detect unauthorized use of a process when the process of an information processing apparatus is executed.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-080373, filed May 16, 2024, which is hereby incorporated by reference herein in its entirety.

What is claimed is:

1. An information processing apparatus configured to detect unauthorized execution of a process, the information processing apparatus comprising:
a monitoring unit configured to monitor a physical input to the information processing apparatus;
a specifying unit configured to specify an execution condition of the process; and
a detecting unit configured to detect unauthorized execution of the process based on the physical input monitored by the monitoring unit and the execution condition specified by the specifying unit.

2. The information processing apparatus according to claim 1, wherein the process is executed via the physical input performed by a user of the information processing apparatus.

3. The information processing apparatus according to claim 1, wherein the monitoring unit monitors a change in a physical quantity generated by a user of the information processing apparatus operating the information processing apparatus.

4. The information processing apparatus according to claim 3, wherein the physical quantity is voltage.

5. The information processing apparatus according to claim 1, wherein the monitoring unit records a time of generation of the physical input performed by a user of the information processing apparatus.

6. The information processing apparatus according to claim 1, wherein the specifying unit specifies, as the execution condition, a physical input which is a precondition for execution of the process.

7. The information processing apparatus according to claim 1, wherein the detecting unit detects unauthorized execution of the process in a case where there is a difference of a threshold or more between a time of generation of an execution request for the process to be executed by the information processing apparatus and a time of generation of the physical input which is a precondition for execution of the process recorded by the monitoring unit.

8. The information processing apparatus according to claim 1 further comprising a security measure unit configured to execute restart of the information processing apparatus and notification to an administrator in a case where the detecting unit detects unauthorized execution of the process.

9. The information processing apparatus according to claim 1, wherein the detecting unit detects an unauthorized change of administrator setting in a case where there is a difference of a threshold or more between a time of generation of a change request for the administrator setting of the information processing apparatus and a time of generation of a physical input related to a change of the administrator setting recorded by the monitoring unit.

10. The information processing apparatus according to claim 1, wherein the detecting unit detects unauthorized execution of the process in a case where there is a difference of a threshold or more between a time of generation of an execution request for the process to be executed by the information processing apparatus and a time of generation of a physical input related to a preliminary operation for execution of the process recorded by the monitoring unit.

11. The information processing apparatus according to claim 10, wherein
the process includes a scan process, and
the preliminary operation includes an open/close operation of a cover for scan.

12. The information processing apparatus according to claim 1, wherein the detecting unit changes a remote user interface (RUI) function for executing a process by remote operation to a disabled status before detecting unauthorized execution of the process.

13. The information processing apparatus according to claim 1, wherein
the monitoring unit further monitors whether or not a user exists near the information processing apparatus using a human sensor, and
the detecting unit detects unauthorized execution of the process in a case where a process preconditioned upon the physical input is executed even though there is no reaction in the human sensor.

14. The information processing apparatus according to claim 1, wherein
the monitoring unit further monitors whether or not a user performs a charging operation for execution of a process using a charging apparatus associated with the information processing apparatus, and
the detecting unit detects unauthorized execution of the process in a case where a process is executed even though the charging operation is not performed.

15. The information processing apparatus according to claim 1 further comprising a setting changing unit configured to enhance a security setting of the information processing apparatus in a case where the detecting unit detects unauthorized execution of the process.

16. The information processing apparatus according to claim 1, wherein the information processing apparatus is an image forming apparatus.

17. A method of controlling an information processing apparatus configured to detect unauthorized execution of a process, the method comprising:
monitoring a physical input to the information processing apparatus;
specifying an execution condition of the process; and
detecting unauthorized execution of the process based on the physical input monitored by the monitoring and the execution condition specified by the specifying.

18. A storage medium storing a program for causing a computer to execute a method of controlling an information processing apparatus configured to detect unauthorized execution of a process, the method comprising:
monitoring a physical input to the information processing apparatus;
specifying an execution condition of the process; and
detecting unauthorized execution of the process based on the physical input monitored by the monitoring and the execution condition specified by the specifying.
